(19) United States
(12) Patent Application Publication
(10) Pub. No.: US 2016/0076739 A1
(43) Pub. Date: Mar. 17, 2016

(54) CONDENSER LENS AND LAMP USING CONDENSER LENS

(71) Applicant: HON HAI PRECISION INDUSTRY CO., LTD., New Taipei (TW)

(72) Inventors: KUANG-MING HSIAO, Tu-Cheng (TW); CHUN-WEI LIANG, Tu-Cheng (TW)

(21) Appl. No.: 14/803,582

(22) Filed: Jul. 20, 2015

(30) Foreign Application Priority Data
Sep. 11, 2014 (CN) 201410458803.1

(51) Int. Cl. F21V 13/04; F21V 7/00; F21V 5/04; F21V 7/04

(52) U.S. Cl. CPC F21V 13/04; F21V 7/041; F21V 7/0033; F21V 7/0066; F21V 5/048; F21Y 2101/02

(57) ABSTRACT

A condenser lens includes a bottom surface, a top surface, and an outwardly curved side surface coupling the bottom surface and the top surface. The bottom surface defines a receiving chamber. The receiving chamber is configured to receive a light source. The top surface is inwardly depressed until reaching a reflection surface. The reflection surface is configured to substantially reflect all light received at the bottom surface. The outwardly curved side surface is configured to substantially reflect all light reflected by the reflection surface, whereby light reflected by the outwardly curved side surface is output from the top surface. The present disclosure further provides a lamp having a condenser lens.

### FIELD

The subject matter herein generally relates to condenser lenses and lamps each having a condenser lens.

### BACKGROUND

Lamps are used in many places and play an important part to our daily life. Lamps were traditionally incandescent in nature which involved the production of light based on some object being heated. More recently, a lamp can include one or more Light Emitting Diodes (LEDs).

### BRIEF DESCRIPTION OF THE DRAWINGS

Implementations of the present technology will now be described, by way of example only, with reference to the attached figures.

FIG. 1 is an isometric view of an embodiment of a lamp having a condenser lens.

FIG. 2 is an exploded, isometric view of the lamp of FIG. 1.

FIG. 3 is an isometric view of the condenser lens of the lamp of FIG. 1.

FIG. 4 is a cross-sectional view of the lamp of FIG. 1, taken along line IV-IV.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “substantially” is defined to be essentially conforming to the particular dimension, shape, or other feature that the term modifies, such that the component need not be exact. For example, “substantially cylindrical” means that the object resembles a cylinder, but can have one or more deviations from a true cylinder. The term “comprising,” when utilized, means “including, but not necessarily limited to”; it specifically indicates open-ended inclusion or membership in the so-described combination, group, series and the like.

A condenser lens is described herein. The condenser lens can include a bottom surface, a top surface, and an outwardly curved side surface coupling the bottom surface and the top surface. The bottom surface can define a receiving chamber. The receiving chamber can be configured to receive a light source. The top surface can be inwardly depressed until reaching a reflection surface. The reflection surface can be configured to substantially reflect all light which has been received at the bottom surface. The outwardly curved side surface can be configured to reflect substantially all light reflected by the reflection surface, whereby light reflected by the outwardly curved side surface are outputted from the top surface.

A lamp is presented herein and can include a condenser lens and an LED light source. The condenser lens can include a bottom surface, a top surface, and an outwardly curved side surface coupling the bottom surface and the top surface. The bottom surface can define a receiving chamber. The top surface can be inwardly depressed until reaching a reflection surface. The reflection surface can be configured to substantially reflect all light which has been received at the bottom surface. The outwardly curved side surface can be configured to reflect substantially all light reflected by the reflection surface, whereby light reflected by the outwardly curved side surface are outputted from the top surface. The LED light source can be received in the receiving chamber.

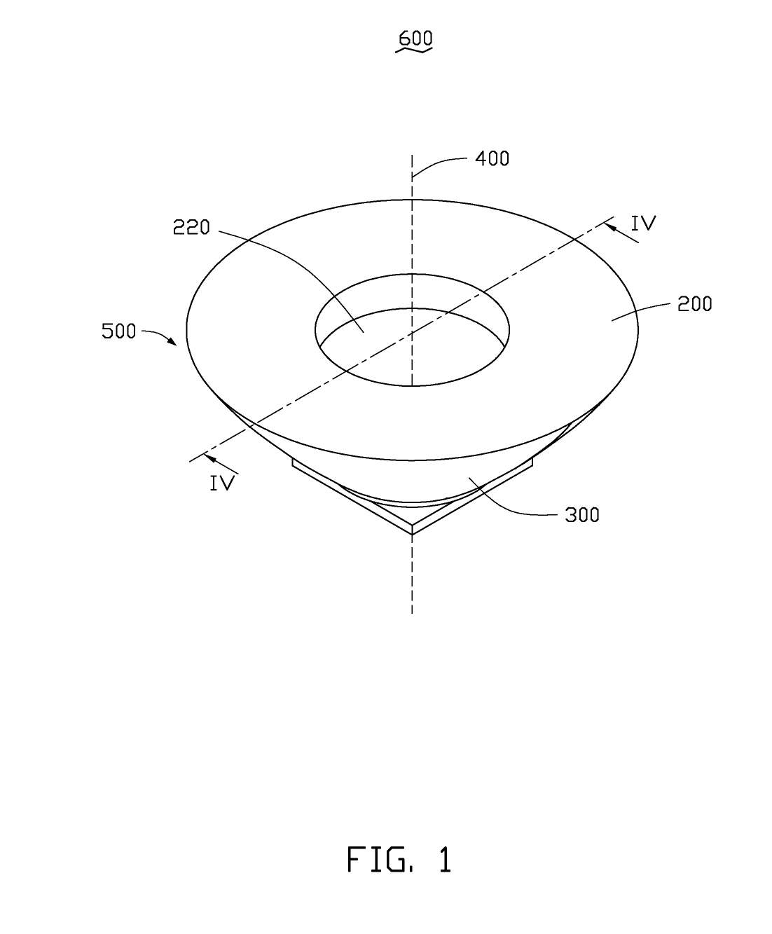

FIG. 1 illustrates an isometric view of an embodiment of a lamp 600 that can include a condenser lens 500. The condenser lens 500 can be a conical lens having a center axis 400. The condenser lens 500 can include a top surface 200 and an outwardly curved side surface 300. The top surface 200 can be substantially circular. A cavity 220 can be inwardly depressed from the top surface 200 along the center axis 400. The top surface 200 can be configured for lights emitting out from the condenser lens 500. In at least one embodiment, the top surface 200 can be equipped with microstructures or Fresnel lens. In at least one embodiment, the top surface 200 can be atomized via sand blasting.

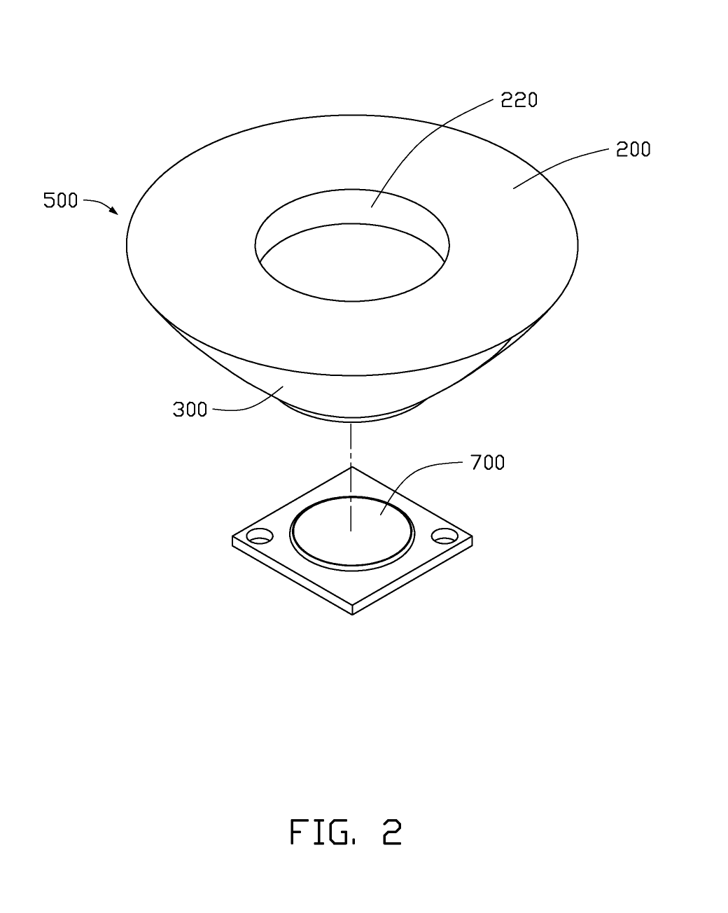

FIG. 2 illustrates that the lamp 600 can further include a Light Emitting Diode (LED) light source 700 coupled to the condenser lens 500. A center axis of the LED light source 700 can coincide with the center axis 400 of the condenser lens 500. In an alternative embodiment, the lamp 600 can include a lampshade or other structures. The LED light source 700 can be a Chip on Board (COB) LED light source or a single chip package LED light source. In the illustrated embodiment, the LED light source 700 is a single chip package LED light source.

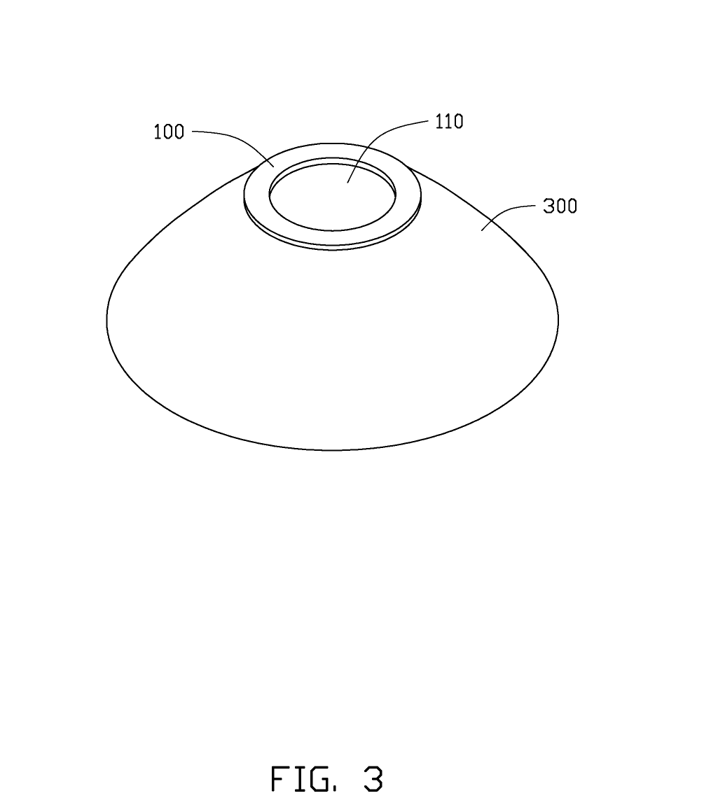

FIG. 3 illustrate that the condenser lens 500 can further include a bottom surface 100 substantially parallel to the top surface 200. The outwardly curved side surface 300 can couple the bottom surface 100 to the top surface 200. The bottom surface 100 can be substantially circular. A diameter of the bottom surface 100 can be smaller than a diameter of the top surface 200. The condenser lens 500 can be made of transparent plastic.

A receiving chamber 110 can be defined on the bottom surface 100. The receiving chamber 110 can be substantially columnar and configured to receive the LED light source 700. Lights emitted by the LED light source 700 can enter to the condenser lens 500 from the bottom surface 100, and the lights emitted by the LED light source 700 can be refracted when entering to the condenser lens 500.

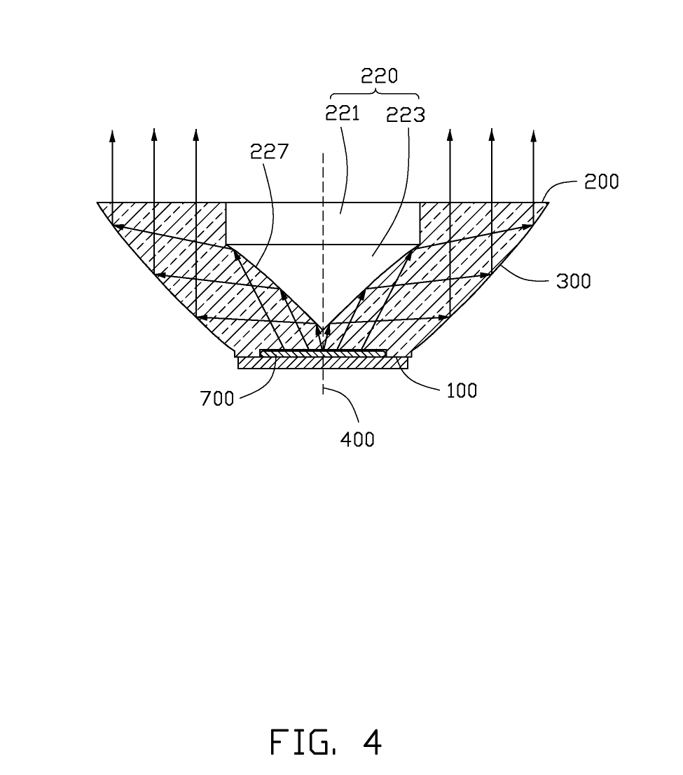

FIG. 4 illustrates that the cavity 220 can be inwardly depressed until reaching a reflection surface 227. The reflection surface 227 can be substantially conical. A center axis of the cavity 220 can be substantially coincide with the center axis 400 of the condenser lens 500. The cavity 220 can include a first hollow part 221 and a second hollow part 223 in communication with the first hollow part 221. The first hollow part 221 can be positioned adjacent to the top surface 200 and substantially columnar. The second hollow part 223 can be positioned adjacent to the bottom surface 100 and substantially conical. The second hollow part 223 can be located below the first hollow part 221. The first hollow part 221 can pass through the top surface 200. The reflection surface 227 can be received in the second hollow part 223, and can surround the second hollow part 223. The reflection surface 227 can be configured to receive lights reflected by the bottom surface 100, and then reflect substantially all light to inside of the condenser lens 500. In at least one embodiment, the reflection surface 227 can be slightly inwardly or outwardly curved. The reflection surface 227 can be treated by plating, or by white reflective paint spraying, or by texture, or by blasting before installation.

The outwardly curved side surface 300 can be another reflection surface of the condenser lens 500 and substantially conical frustum shaped. The outwardly curved side surface 300 can be configured to reflect light reflected by the reflection surface 227. Therefore, light reflected by the outwardly curved side surface 300 can be parallel to the center axis 400 and output from the top surface 200. The outwardly curved side surface 300 can be treated by plating, or by white reflective paint spraying, or by texture, or by blasting.

When in use, the LED light source 700 can be received in the receiving chamber 110 of the condenser lens 500, and the center axis of the LED light source 700 can be coincide with the center axis 400 of the condenser lens 500. Lights emitted by the LED light source 700 can be transmitted outside from the top surface 200 after being substantially reflected by the reflection surface 227 and substantially reflected by the outwardly curved side surface 300. The output lights can be substantially perpendicular to the top surface 200.

In an alternative embodiment, the condenser lens 500 can be made of transparent PMMA (polymethyl methacrylate), or glass, or other transparent materials. The outwardly curved side surface 300 can be designed to reflect lights in other angles. The top surface 200 can equipped with structures for evenly outputting lights.

The embodiments shown and described above are only examples. Many details are often found in the art such as the other features of a lamp and a condenser lens. Therefore, many such details are neither shown nor described. Even though numerous characteristics and advantages of the present technology have been set forth in the foregoing description, together with details of the structure and function of the present disclosure, the disclosure is illustrative only, and changes may be made in the details, including in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. A condenser lens comprising:
a bottom surface defining a receiving chamber configured to receive a light source;
a top surface substantially parallel to the bottom surface, the top surface inwardly depressed until reaching a reflection surface, the reflection surface configured to reflect substantially all light received at the bottom surface; and
an outwardly curved side surface coupling the bottom surface and the top surface, the outwardly curved side surface configured to reflect substantially all the light reflected by the reflection surface, whereby light reflected by the outwardly curved side surface is output from the top surface.

2. The condenser lens of claim 1, wherein a cavity is inwardly depressed from the top surface along a center axis of the condenser lens until reaching the reflection surface, the reflection surface is received in the cavity.

3. The condenser lens of claim 2, wherein the cavity comprises a first hollow part and a second hollow part in communication with the first hollow part, the first hollow part is positioned adjacent to the top surface and substantially columnar, the second hollow part is positioned adjacent to the bottom surface and substantially conical, the first hollow part passes through the top surface, the reflection surface surrounds the second hollow part.

4. The condenser lens of claim 1, wherein the bottom surface and the top surface each substantially circular, a diameter of the bottom surface is smaller than a diameter of the top surface.

5. The condenser lens of claim 1, wherein the condenser lens is made of transparent plastic.

6. The condenser lens of claim 1, wherein the reflection surface is substantially conical.

7. The condenser lens of claim 1, wherein the outwardly curved side surface is substantially conical frustum shaped.

8. The condenser lens of claim 1, wherein a center axis of the cavity is substantially coincide with a center axis of the condenser lens.

9. A lamp, comprising:
a condenser lens comprising:
a bottom surface defining a receiving chamber,
a top surface inwardly depressed until reaching a reflection surface, the reflection surface configured to substantially reflect all light received at the bottom surface, and
an outwardly curved side surface coupling the bottom surface and the top surface, the outwardly curved side surface configured to reflect substantially all light reflected by the reflection surface, whereby light reflected by the outwardly curved side surface is output from the top surface; and
at least one LED light source received in the receiving chamber.

10. The lamp of claim 9, wherein a cavity is inwardly depressed from the top surface along a center axis of the condenser lens until reaching the reflection surface, the reflection surface is received in the cavity.

11. The lamp of claim 10, wherein the cavity comprises a first hollow part and a second hollow part in communication with the first hollow part, the first hollow part is positioned adjacent to the top surface and substantially columnar, the second hollow part is positioned adjacent to the bottom surface and substantially conical.

12. The lamp of claim 11, wherein the first hollow part passes through the top surface, the reflection surface encircles the second hollow part.

13. The lamp of claim 9, wherein the bottom surface and the top surface each substantially circular, a diameter of the bottom surface is smaller than a diameter of the top surface.

14. The lamp of claim 9, wherein the condenser lens is made of transparent plastic.

15. The lamp of claim 9, wherein the reflection surface is substantially conical.

16. The lamp of claim 9, wherein the outwardly curved side surface is substantially conical frustum shaped.

17. The lamp of claim 9, wherein a center axis of the cavity is substantially coincide with a center axis of the condenser lens.

18. The lamp of claim 9, wherein the top surface is substantially parallel to the bottom surface.
